(19) United States
(12) Patent Application Publication
(10) Pub. No.: US 2020/0109252 A1
(43) Pub. Date: Apr. 9, 2020

(54) RUBBER COMPOSITION, AND PNEUMATIC TIRE

(71) Applicant: Toyo Tire Corporation, Itami-shi (JP)

(72) Inventor: Tsunetaka Mukai, Itami-shi (JP)

(73) Assignee: Toyo Tire Corporation, Itami-shi (JP)

(21) Appl. No.: 16/590,800

(22) Filed: Oct. 2, 2019

(30) Foreign Application Priority Data
Oct. 4, 2018 (JP) 2018-188948
Oct. 4, 2018 (JP) 2018-188956
Oct. 4, 2018 (JP) 2018-189005

(51) Int. Cl. C08K 3/34; C08L 7/00; B60C 1/00; B60C 9/00

(52) U.S. Cl. CPC C08K 3/34; C08L 7/00; B60C 2009/0021; B60C 9/0007; C08L 2312/00; B60C 1/0016

(57) ABSTRACT

A rubber composition is disclosed which includes an inorganic compound, the inorganic compound being an aluminum silicate represented by general formula (1): xAl₂O₃.ySiO₂.zH₂O in which x and y are each independently an integer, y/x≥5, and z is a positive number; and an amount of the inorganic compound being less than 15 parts by weight for 100 parts by weight of a rubber component in the rubber composition. The rubber composition of the invention can give a vulcanized rubber which can restrain an odor peculiar to tires (i.e., which has a low odor property).

### BACKGROUND OF THE INVENTION

### Field of the Invention

The present invention relates to a rubber composition, and a pneumatic tire.

### Description of the Related Art

As a rubber composition used for pneumatic tires, for example, the following has been hitherto known: a rubber composition containing a specific inorganic compound, such as aluminum hydroxide, to have, for example, a tire on-ice performance; or a rubber composition containing a highly absorbing filler, such as imogolite, to be capable of restraining water from permeating the composition (Patent Documents 1 and 2).

### PRIOR ART DOCUMENTS

### Patent Documents

Patent Document 1: JP-A-2009-173838

Patent Document 2: JP-A-2013-82280

### SUMMARY OF THE INVENTION

In recent years, in (large-sized) tires used, in particular, for heavy loads such as trucks, buses and construction vehicles, out of tires (vulcanized rubbers) each yielded using a rubber composition as raw material, an odor peculiar to the tires has come to be problematized. However, vulcanized rubbers yielded from a rubber composition as described in the above-mentioned patent documents have been unable to solve this problem.

In pneumatic tires, particularly, radial tires, steel cords and other cords have been frequently used as their reinforcing members (such as belt layers, carcass layers or chafer layers) for passenger car tires or (large-sized) tires used in the above-mentioned heavy loads. About such a steel cord, a rubber and the steel cord are easily peeled off from each other at their interface, in particular, by a lowering in adhesiveness (wet heat resistant adhesiveness) therebetween, this lowering being caused by water penetration thereinto while the tires are used, or by humidity-absorption and temperature-rising of the tires while the tires are produced or stored. Thus, the steel cord has a problem of suffering from a problem of the generation of separation.

In the light of the above-mentioned actual situation, the present invention has been made. A first object thereof is to provide a rubber composition which can give a vulcanized rubber that can restrain an odor peculiar to tires.

Moreover, in the light of the actual situation, the present invention has been made. A second object thereof is to provide a rubber composition for a shoulder pad which can give a vulcanized rubber that can restrain an odor peculiar to tires (i.e., that has a low odor property).

In the light of the above-mentioned actual situation, the present invention has been made. A third object thereof is to provide a rubber composition for steel cord covering which can give a vulcanized rubber that can restrain an odor peculiar to tires (i.e., that has a low odor property) and that is excellent in wet heat resistant adhesiveness.

The present invention relates to a rubber composition including an inorganic compound, the inorganic compound being an aluminum silicate represented by general formula (1): xAZO₃.ySiO₂.zH₂O in which x and y are each independently an integer, y/x≥5, and z is a positive number; and an amount of the inorganic compound being less than 15 parts by weight for 100 parts by weight of a rubber component in the rubber composition.

The present invention also relates to a pneumatic tire using the above-defined rubber composition.

Details of the action mechanism of advantageous effects of the rubber composition according to the present invention are partially unclear; however, the mechanism is presumed as described below. However, the invention may not be interpreted with limitation to this action mechanism.

The rubber composition of the present invention includes, as an inorganic compound, at least an aluminum silicate represented by general formula (1): xAl₂O₃.ySiO₂.zH₂O in which x and y are each independently an integer, y/x≥5, and z is a positive number. The inventors have made eager investigations and consequently found that a peculiar odor (foul-smell-causing substance) contained in tires (vulcanized rubbers) is mainly an aromatic compound or some other hydrophobic substance that is derived from natural rubber or a vulcanization-related component such as a vulcanizer or a vulcanization promoter. The aluminum silicate is higher in hydrophobicity as the value of the bonding ratio between SiO₂ and Al₂O₃ therein (ratio SiO₂/Al₂O₃) is higher. It is therefore presumed that the above-mentioned inorganic compound (aluminum silicate represented by the general formula (1)) contained in the rubber composition of the present invention can effectively adsorb the peculiar odor (foul-smell-causing substance) contained in tires (vulcanized rubbers). Thus, according to the rubber composition of the present invention, a vulcanized rubber can be obtained which can restrain the odor peculiar to tires (i.e., which has a low odor property).

As described above, it is also presumed that the inorganic compound (aluminum silicate represented by the general formula (1)) unfavorably adsorbs vulcanization-related components also. Thus, the use of an excessive amount of the inorganic compound unfavorably hinders the rubber composition from being vulcanized to lower the composition in vulcanizing rate. However, in the rubber composition of the present invention, the inorganic compound (aluminum silicate represented by the general formula (1)) is used in an amount less than 15 parts by weight for 100 parts by weight of the rubber component in the rubber composition. Accordingly, a fall in the vulcanizing rate can be restrained.

Moreover, the inorganic compound (aluminum silicate represented by the general formula (1)) has a filler volume effect (reinforcing effect). Thus, it can be expected that the effect improves the resultant vulcanized rubber in storage elastic modulus to heighten the rubber in rubber strength.

It is presumed that a hydrophobic substance as described above, which is derived from a vulcanization-related component, causes a lowering in wet heat resistant adhesiveness between a rubber and a steel cord. However, the use of the inorganic compound (aluminum silicate represented by the general formula (1)) enables to adsorb this substance, so that the rubber composition of the present invention can give a vulcanized rubber excellent in wet heat resistant adhesiveness.

### DETAILED DESCRIPTION OF THE PREFERRED EMBODIMENTS

### <Rubber Composition>

The rubber composition of the present invention includes at least an inorganic compound, the inorganic compound being an aluminum silicate represented by general formula (1): xAl₂O₃.ySiO₂.zH₂O in which x and y are each independently an integer, y/x≥5, and z is a positive number, and an amount of the inorganic compound being less than 15 parts by weight for 100 parts by weight of a rubber component in the rubber composition.

### <Inorganic Compound>

The inorganic compound in the present invention is an aluminum silicate (synthesized aluminum silicate) represented by general formula (1): xAl₂O₃.ySiO₂.zH₂O in which x and y are each independently an integer, y/x≥5, and z is a positive number.

In the general formula (1), x and y are not particularly limited as far as x and y satisfy “y/x≥5”, and are each an integer of a value for attaining the production of the aluminum silicate (synthesized aluminum silicate). Furthermore, z is not particularly limited as far as z is a positive number for attaining the production of the aluminum silicate (synthesized aluminum silicate), and is usually a positive number of 10 or less.

The inorganic compound is, for example, Al₂O₃.9SiO₂.zH₂O “KYOWAAD 700” manufactured by Kyowa Chemical Industry Co., Ltd. as a commercially available product.

The amount of the inorganic compound is less than 15 parts by weight for 100 parts by weight of the rubber component in the rubber composition. From the viewpoint of a restraint of a peculiar odor contained in the resultant tire (vulcanized rubber) the amount of the inorganic compound is preferably 0.3 parts or more, more preferably 0.5 parts or more, even more preferably 1 part or more, even more preferably 2 parts or more by weight for 100 parts by weight of the rubber component in the rubber composition. From the viewpoint of a restraint of a lowering of the composition in vulcanizing rate, the amount of the inorganic compound is preferably 12 parts or less, more preferably 10 parts or less, even more preferably 8 parts or less by weight for 100 parts by weight of the rubber component in the rubber composition. In order to prevent the vulcanized rubber from being lowered in wet heat resistant adhesiveness by the use of an excessive amount of the inorganic compound, the amount of the inorganic compound is 12 parts or less, more preferably 10 parts or less by weight for 100 parts by weight of the rubber component in the rubber composition.

### <Rubber, Carbon Black, and Various Blending Agents>

In the present invention, a rubber composition can be prepared by using the above-defined inorganic compound. Raw materials of the rubber composition may be a rubber, a carbon black and various blending agents that are usually used in the rubbery industry.

Examples of the rubber include natural rubber (NR); and synthetic diene rubbers such as isoprene rubber (IR), styrene-butadiene rubber (SBR), butadiene rubber (BR), chloroprene rubber (CR), and nitrile rubber (NBR). Such rubbers may be used singly or in any combination of two or more thereof.

The carbon black may be any carbon black species used in an ordinary rubbery industry, such as SAF, ISAF, HAF, FEF, or GPF. The carbon black may also be an electroconductive carbon black such as acetylene black or Ketchen black. The carbon black may be any granulated carbon black, which has been granulated, considering the handleability of the carbon black in an ordinary rubbery industry; or a non-granulated carbon black. Such carbon blacks may be used singly or in any combination of two or more thereof.

About the carbon black, the nitrogen adsorption specific surface area thereof is preferably from about 25 m²/g to about 250 m²/g both inclusive, more preferably from about 50 m²/g to about 200 m²/g both inclusive. When the rubber composition is used for a tire tread, from the viewpoint of an improvement of the tire (vulcanized rubber) in reinforce ability the nitrogen adsorption specific area is preferably from about 70 m²/g to about 180 m²/g both inclusive, more preferably from about 90 m²/g to about 150 m²/g both inclusive. When the rubber composition is used for a shoulder pad, from the viewpoint of an improvement of the tire (vulcanized rubber) for the shoulder pad in low exothermicity the nitrogen adsorption specific area is preferably from about 25 m²/g to about 120 m²/g both inclusive, more preferably from about 50 m²/g to about 90 m²/g both inclusive. When the rubber composition is used for steel cord covering, from the viewpoint of an improvement of the tire (vulcanized rubber) for steel cord covering in durability the nitrogen adsorption specific area is preferably from about 30 m²/g to about 200 m²/g both inclusive, more preferably from about 50 m²/g to about 100 m²/g both inclusive.

The amount of the carbon black is preferably from 10 to 120 parts by weight for 100 parts by weight of the rubber component in the rubber composition. About the carbon black, from the viewpoint of an improvement thereof in vulcanized-rubber-reinforcing performance, the amount is 20 parts or more, more preferably 30 parts or more by weight for 100 parts by weight of the rubber component in the rubber composition, and is preferably 100 parts or less, more preferably 80 parts or less by weight therefor.

Examples of the various blending agents include a sulfur-based vulcanizer, a vulcanization promoter, an antiaging agent, silica, a silane coupling agent, zinc oxide, a methylene receptor and a methylene donor, an organic acid cobalt salt, stearic acid, a vulcanization promotion aid, a vulcanization retarder, an organic peroxide, softeners such as wax and oil, and a processing aid.

The vulcanizer may be an ordinary vulcanizer for rubbers, and is preferably a sulfur-based vulcanizer. The species of sulfur for the sulfur-based vulcanizer may be any ordinary sulfur species for rubbers. Examples of the species include powdery sulfur, precipitated sulfur, insoluble sulfur, and highly dispersed sulfur. Such vulcanizers may be used singly or in any combination of two or more thereof.

The vulcanizer content is preferably from 0.5 to 15 parts, more preferably from 1 to 10 parts by weight for 100 parts by weight of the rubber component in the rubber composition.

The vulcanization promoter may be any ordinary vulcanization promoter for rubbers. Examples thereof include sulfenamide based, thiuram based, thiazole based, thiourea based, guanidine based and dithiocarbamic acid salt based vulcanization promoters. Such vulcanization promoters may be used singly or in any combination of two or more thereof.

The vulcanization promoter content is preferably from 0.5 to 5 parts, more preferably from 1 to 3 parts by weight for 100 parts by weight of the rubber component in the rubber composition.

When the vulcanizer and the vulcanization promoter are used as two of the various blending agents, the ratio by weight of the inorganic compound to the total of the vulcanizer and the vulcanization promoter (the “inorganic compound”/(the “vulcanizer”+the “vulcanization promoter”)) is preferably 4 or less, more preferably 3 or less, even more preferably 2.5 or less to restrain a lowering of the rubber composition in vulcanizing rate. Moreover, the ratio by weight of the inorganic compound to the total of the vulcanizer and the vulcanization promoter (the “inorganic compound”/(the “vulcanizer”+the “vulcanization promoter”)) is preferably from 0.05 to 1.5 both inclusive, more preferably from 0.1 to 1.2 both inclusive to improve the rubber composition in wet heat resistant adhesiveness.

The antiaging agent may be any ordinary antiaging agent for rubbers. Examples thereof include aromatic amine based, amine-ketone based, monophenol based, bisphenol based, polyphenol based, dithiocarbamic acid salt based, and thiourea based antiaging agents. Such antiaging agents may be used singly or in any combination of two or more thereof.

The antiaging agent content is preferably from 1 to 5 parts by weight for 100 parts by weight of the rubber component in the rubber composition.

The methylene receptor and the methylene donor can make the rubber and a steel cord high in adhesiveness therebetween by curing-reaction between hydroxy groups of the methylene receptor and methylene groups of the methylene donor to allow to restrain adhesiveness between the rubber and the cord from being deteriorated by load and heat-generation which follow the running of the tire.

Examples of the methylene receptor include phenolic compounds, and phenolic resins each yielded by condensing any one of the phenolic compounds with formaldehyde. Examples of the phenolic compounds include phenol, resorcin, and alkyl derivatives of these compounds. Examples of the alkyl derivatives include cresol, xylenol, and other methyl-derivatives of the compounds; and nonylphenol, octylphenol, and other derivatives of the compounds that each have an alkyl group that is a relatively long chain. The phenolic compounds may each be a compound containing, as a substituent, an acyl group such as an acetyl group.

Examples of the phenolic resins include resorcin-formaldehyde resins, phenol resins (i.e., phenol-formaldehyde resins), cresol resins (i.e., cresol-formaldehyde resins), and formaldehyde resins composed of plural phenolic compounds. As the phenolic resins, resins are used which are uncured resins that are in a liquid form or have thermal fluidity.

The methylene receptor is preferably resorcin or a resorcin derivative, more preferably resorcin, or a resorcin-alkylphenol-formalin resin from the viewpoint of the compatibility thereof with the rubber component or other components, and the denseness and reliability of the resin after the resin is cured.

The methylene receptor content is preferably from 0.5 to 10 parts, more preferably from 1 to 5 parts by weight for 100 parts by weight of the rubber component in the rubber composition.

Examples of the methylene donor include hexamethylenetetramine, and melamine derivatives. Examples of the melamine derivatives include methylolmelamine, partially etherized compounds of methylolmelamine, and condensed products each made from melamine, formaldehyde and methanol. Hexamethoxymethylmelamine is preferred.

The methylene donor content is preferably from 0.5 to 10 parts, more preferably from 1 to 5 parts by weight for 100 parts by weight of the rubber component in the rubber composition.

The organic acid cobalt salt can improve adhesiveness between the rubber and a steel cord. Examples of the organic acid cobalt salt include cobalt naphthenate, cobalt stearate, cobalt oleate, cobalt neodecanoate, cobalt rosinate, cobalt borate, and cobalt maleate. Out of these salts, cobalt naphthenate, and cobalt stearate are preferred from the viewpoint of the workability of the rubber composition.

The content of the organic acid cobalt salt is preferably from 0.03 to 0.5 parts by weight for 100 parts by weight of the rubber component in the rubber composition.

The method for blending (or adding) the inorganic compound, the rubber, the carbon black, and the various blending agents into each other is, for example, a method of kneading these components using a kneading machine used in an ordinary rubber industry, such as a Banbury mixer, a kneader, or a roll.

The kneading method is not particularly limited, and is, for example, a method of adding components other than vulcanization-related components, such a sulfur based vulcanizer and a vulcanization promoter, to each other in any order; of adding these components to each other simultaneously, so as to knead these components; or of adding all the components to each other simultaneously to knead the components. The number of times of the kneading may be one or plural. The period for the kneading is varied in accordance with the size of the kneading machine to be used, and other factors. It is advisable to set the period usually into the range of about 2 to 5 minutes. The discharging-temperature of the rubber composition in the kneading machine is set to a range preferably from 120 to 170° C., more preferably from 120 to 150° C. When the rubber composition includes one or more of the vulcanization-related components, the discharging-temperature in the kneading machine is set to a range preferably from 80 to 110° C., more preferably from 80 to 100° C.

A vulcanized rubber yielded from the rubber composition of the present invention can restrain an odor peculiar to tires; thus, the rubber is suitable for pneumatic tires, and is in particular suitable for (large-sized) tires for heavy loads, such as trucks, buses or construction vehicles. A moiety of the tires in which the rubber is used is not particularly limited, and is preferably a tire tread, which constitutes a ground-contacting surface of the tire. The vulcanized rubber yielded from the rubber composition of the invention is high in storage elastic modulus, and excellent in strength to be suitable for a shoulder pad. The vulcanized rubber yielded from the rubber composition of the invention is excellent in wet heat resistant adhesiveness to be suitable for steel cord covering.

### EXAMPLES

Hereinafter, the present invention will be described by way of working examples thereof. However, the invention is never limited by these working examples.

Hereinafter, embodiments related to the first object will be described.

### (Used Raw Materials)

a) Natural rubber: “RSS #3”;

b) Carbon black: “SEAST 6 (ISAF)” (manufactured by Tokai Carbon Co., Ltd.; nitrogen adsorption specific surface area: 119 m²/g);

c) Inorganic compound (A): Al₂O₃.9SiO₂.zH₂O “KYOWAAD 700SL” (manufactured by Kyowa Chemical Industry Co., Ltd.);

d) Inorganic compound (B): Al₂O₃.9SiO₂.zH₂O “KYOWAAD 700PL” (manufactured by Kyowa Chemical Industry Co., Ltd.);

e) Inorganic compound (C): Al₂O₃.2SiO₂.zH₂O “HARD CLAY” (manufactured by Shiraishi Kogyo Kaisha, Ltd.);

f) Inorganic compound (D): Mg_{0.7}Al_{0.3}O_{1.15} “KW-2000” (manufactured by Kyowa Chemical Industry Co., Ltd.);

g) Zinc oxide: “Zinc Oxide, Species 2” (manufactured by Mitsui Mining & Smelting Co., Ltd.);

h) Stearic acid: “BEADS STEARIC ACID” (manufactured by NOF Corp.);

i) Antiaging agent: “NOCRAC 6C” (manufactured by Ouchi Shinko Chemical Industrial Co., Ltd.);

j) Sulfur: “5%-OIL-INCORPORATED FINELY-POWDERY SULFUR” (manufactured by Tsurumi Chemical Industry Co., Ltd.); and

k) Vulcanization promoter: N-cyclohexyl-2-benzothiazole sulfenamide: “SUNCELLER CM-G” (manufactured by Sanshin Chemical Industry Co., Ltd.).

### Examples 1 to 6, and Comparative Examples 1 to 4

### <Production of Rubber Compositions and Unvulcanized Rubber Compositions>

In each of the examples, a Banbury mixer was used to dry-mix individual raw materials (i.e., components other than any sulfur and any vulcanization promoter) shown in Table 1 (kneading period: 3 minutes; composition-discharging-temperature: 150° C.). In this way, a rubber composition was produced. Next, to the resultant rubber composition were added a sulfur and a vulcanization promoter that are shown in Table 1, and then the Banbury mixer was used to dry-mix all the components (kneading period: 1 minute; composition-discharging-temperature: 90° C.). In this way, an unvulcanized rubber composition was produced. The blend proportion of any component in Table 1 is represented by the numerical value of the part(s) by weight (phr) of this component when the amount of the rubber component contained in the corresponding rubber composition is regarded as 100 parts by weight.

The unvulcanized rubber composition yielded in each of the working examples and the comparative examples was evaluated as described below. The evaluation results are shown in Table 1.

### <Vulcanizing Rate Evaluation>

About an evaluation of the vulcanizing rate of the unvulcanized rubber composition, in accordance with JIS K6300-2, a vulcanization curve of this composition was measured at 160° C. The maximum value (Fₘₐₓ) and the minimum value (Fₘᵢₙ) of the torque in the vulcanization curve were measured, and then the following was calculated out: t90=((Fₘₐₓ−Fₘᵢₙ)×0.9+Fₘᵢₙ). The resultant value was represented as an index relative to the value of that in Comparative Example 1, which was regarded as 100. It is demonstrated that as the index is larger, the vulcanizing rate is smaller.

### <Vulcanized Rubber Production>

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 1.

### <Odor Property Evaluation>

About an evaluation of the odor property of the vulcanized rubber, in accordance with JIS Z9080, into a 5 L bag made of polyethylene terephthalate were put 100 g of a shaped sheet (made of the vulcanized rubber) and an odorless air yielded by passing air through activated charcoal. The sheet was stored at a room temperature of 60° C. for 2 hours. The air inside the resultant odor bag was subjected to a sensory evaluation for grading the odor into 6 stages described below. The odor was evaluated according to the average of results obtained by five panelists.

1: No odor is felt.

2: The air gives a very faint odor.

3: The air gives a faint odor.

4: The air gives an odor clearly.

5: The air gives an odor strongly.

6: The air gives an odor very strongly.

TABLE 1

| | Comparative | Comparative | Comparative | Comparative | | | | | | |
|---|---|---|---|---|---|---|---|---|---|---|
| | Example 1 | Example 2 | Example 3 | Example 4 | Example 1 | Example 2 | Example 3 | Example 4 | Example 5 | Example 6 |
| Natural rubber | 100 | 100 | 100 | 100 | 100 | 100 | 100 | 100 | 100 | 100 |
| Carbon black | 50 | 50 | 50 | 50 | 50 | 50 | 50 | 50 | 50 | 50 |
| Inorganic | | | | 15 | 0.5 | 1 | 3 | 10 | 10 | |
| compound (A) | | | | | | | | | | |
| Inorganic | | | | | | | | | | 3 |
| compound (B) | | | | | | | | | | |
| Inorganic | | 3 | | | | | | | | |
| compound (C) | | | | | | | | | | |
| Inorganic | | | 3 | | | | | | | |
| compound (D) | | | | | | | | | | |
| Zinc oxide | 3 | 3 | 3 | 3 | 3 | 3 | 3 | 3 | 3 | 3 |
| Stearic acid | 2 | 2 | 2 | 2 | 2 | 2 | 2 | 2 | 2 | 2 |
| Antiaging agent | 2 | 2 | 2 | 2 | 2 | 2 | 2 | 2 | 2 | 2 |
| Sulfur | 2 | 2 | 2 | 2 | 2 | 2 | 2 | 2 | 2.2 | 2 |
| Vulcanization | 1.5 | 1.5 | 1.5 | 1.5 | 1.5 | 1.5 | 1.5 | 1.5 | 2 | 1.5 |
| promoter | | | | | | | | | | |
| Odor property | 5 | 5 | 6 | 2 | 3 | 3 | 2 | 2 | 2 | 3 |
| Vulcanizing rate | 100 | 101 | 52 | 121 | 100 | 102 | 101 | 110 | 100 | 101 |

Hereinafter, embodiments related to the second object will be described.

(Used raw materials)

a) Natural rubber: “RSS #3”;

b) Carbon black: “SEAST 300 (HAF-LS)” (manufactured by Tokai Carbon Co., Ltd.);

c) Inorganic compound (A): Al₂O₃.9SiO₂.zH₂O “KYOWAAD 700SL” (manufactured by Kyowa Chemical Industry Co., Ltd.);

d) Inorganic compound (B): Al₂O₃.9SiO₂.zH₂O “KYOWAAD 700PL” (manufactured by Kyowa Chemical Industry Co., Ltd.);

e) Inorganic compound (C): Al₂O₃.2SiO₂.zH₂O “HARD CLAY” (manufactured by Shiraishi Kogyo Kaisha, Ltd.);

f) Inorganic compound (D): Mg_{0.7}Al_{0.3}O_{1.15} “KW-2000” (manufactured by Kyowa Chemical Industry Co., Ltd.);

g) Zinc oxide: “Zinc Oxide, Species 2” (manufactured by Mitsui Mining & Smelting Co., Ltd.);

h) Stearic acid: “BEADS STEARIC ACID” (manufactured by NOF Corp.);

i) Oil: “PROCESS NC140” (manufactured by Japan Energy Corp.);

j) Antiaging agent: “NOCRAC 6C” (manufactured by Ouchi Shinko Chemical Industrial Co., Ltd.);

k) Sulfur: “5%-OIL-INCORPORATED FINELY-POWDERY SULFUR” (manufactured by Tsurumi Chemical Industry Co., Ltd.); and

l) Vulcanization promoter: N-cyclohexyl-2-benzothiazole sulfenamide: “SUNCELLER CM-G” (manufactured by Sanshin Chemical Industry Co., Ltd.).

### Examples 1 to 5, and Comparative Examples 1 to 4

### <Production of Rubber Compositions and Unvulcanized Rubber Compositions>

In each of the examples, a Banbury mixer was used to dry-mix individual raw materials (i.e., components other than any sulfur and any vulcanization promoter) shown in Table 2 (kneading period: 3 minutes; composition-discharging-temperature: 150° C.). In this way, a rubber composition was produced. Next, to the resultant rubber composition were added a sulfur and a vulcanization promoter that are shown in Table 2, and then the Banbury mixer was used to dry-mix all the components (kneading period: 1 minute; composition-discharging-temperature: 90° C.). In this way, an unvulcanized rubber composition was produced. The blend proportion of any component in Table 2 is represented by the numerical value of the part(s) by weight (phr) of this component when the amount of the rubber component contained in the corresponding rubber composition is regarded as 100 parts by weight.

The unvulcanized rubber composition yielded in each of the working examples and the comparative examples was evaluated as described below. The evaluation results are shown in Table 2.

### <Vulcanizing Rate Evaluation>

About an evaluation of the vulcanizing rate of the unvulcanized rubber composition, in accordance with K6300-2, a vulcanization curve of this composition was measured at 160° C. The maximum value (Fₘₐₓ) and the minimum value (Fₘᵢₙ) of the torque in the vulcanization curve were measured, and then the following was calculated out: t90={(Fₘₐₓ−Fₘᵢₙ)×0.9+Fₘᵢₙ)}. The resultant value was represented as an index relative to the value of that in Comparative Example 1, which was regarded as 100. It is demonstrated that as the index is larger, the vulcanizing rate is smaller.

### <Vulcanized Rubber Production>

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 2.

### <Odor Property Evaluation>

About an evaluation of the odor property of the vulcanized rubber, in accordance with JIS Z9080, into a 5 L bag made of polyethylene terephthalate were put 100 g of a shaped sheet (made of the vulcanized rubber) and an odorless air yielded by passing air through activated charcoal. The sheet was stored at a room temperature of 60° C. for 2 hours. The air inside the resultant odor bag was subjected to a sensory evaluation for grading the odor into 6 stages described below. The odor was evaluated according to the average of results obtained by five panelists.

1: No odor is felt.

2: The air gives a very faint odor.

3: The air gives a faint odor.

4: The air gives an odor clearly.

5: The air gives an odor strongly.

6: The air gives an odor very strongly.

### <Storage Elastic Modulus Evaluation>

About the storage elastic modulus of the rubber, a viscoelasticity spectrometer manufactured by Toyo Seiki Co., Ltd. was used to measure the storage elastic modulus E′ thereof at a frequency of 50 Hz, an initial strain of 10%, a dynamic strain of 2% and a temperature of 60° C. The resultant value was represented as an index relative to the value of that in Comparative Example 1, which was regarded as 100. As the index is larger, the rubber is larger in storage elastic modulus E′ to be expected to be higher in rubber strength.

TABLE 2

| | Comparative | Comparative | Comparative | Comparative | | | | | |
|---|---|---|---|---|---|---|---|---|---|
| | Example 1 | Example 2 | Example 3 | Example 4 | Example 1 | Example 2 | Example 3 | Example 4 | Example 5 |
| Natural rubber | 100 | 100 | 100 | 100 | 100 | 100 | 100 | 100 | 100 |
| Carbon black | 35 | 35 | 35 | 35 | 35 | 35 | 35 | 35 | 35 |
| Inorganic compound (A) | | | | 15 | 0.5 | 1 | 3 | 5 | |
| Inorganic compound (B) | | | | | | | | | 3 |
| Inorganic compound (C) | | 3 | | | | | | | |
| Inorganic compound (D) | | | 3 | | | | | | |
| Zinc oxide | 3 | 3 | 3 | 3 | 3 | 3 | 3 | 3 | 3 |
| Stearic acid | 2 | 2 | 2 | 2 | 2 | 2 | 2 | 2 | 2 |
| Oil | 3 | 3 | 3 | 3 | 3 | 3 | 3 | 3 | 3 |
| Antiaging agent | 2 | 2 | 2 | 2 | 2 | 2 | 2 | 2 | 2 |
| Sulfur | 4 | 4 | 4 | 4 | 4 | 4 | 4 | 4 | 4 |
| Vulcanization promoter | 1.5 | 1.5 | 1.5 | 1.5 | 1.5 | 1.5 | 1.5 | 1.5 | 1.5 |
| Odor property | 5 | 5 | 6 | 2 | 3 | 3 | 2 | 1 | 3 |
| Vulcanizing rate | 100 | 101 | 50 | 127 | 100 | 102 | 101 | 110 | 101 |
| Storage elastic | 100 | 98 | 75 | 122 | 103 | 105 | 108 | 112 | 106 |
| modulus | | | | | | | | | |

Hereinafter, embodiments related to the third object will be described.

### (Used Raw Materials)

a) Natural rubber: “RSS #3”;

b) Carbon black: “SEAST 300 (HAF-LS)” (manufactured by Tokai Carbon Co., Ltd.);

c) Inorganic compound (A): Al₂O₃.9SiO₂.zH₂O “KYOWAAD 700SL” (manufactured by Kyowa Chemical Industry Co., Ltd.);

d) Inorganic compound (B): Al₂O₃.9SiO₂.zH₂O “KYOWAAD 700PL” (manufactured by Kyowa Chemical Industry Co., Ltd.);

e) Inorganic compound (C): Al₂O₃.2SiO₂.zH₂O “HARD CLAY” (manufactured by Shiraishi Kogyo Kaisha, Ltd.);

f) Inorganic compound (D): Mg_{0.7}Al_{0.3}O_{1.15} “KW-2000” (manufactured by Kyowa Chemical Industry Co., Ltd.);

g) Methylene receptor: Resorcin/alkyl phenol/formalin resin, “SUMIKANOL 620” (manufactured by Sumitomo Chemical Co., Ltd.);

h) Methylene donor: Hexamethoxymethylmelamine “CYLETS 963L” (manufactured by Mitsui Cytec Ltd.);

i) Organic acid cobalt salt: Cobalt stearate “Corebond CS-9.5” (manufactured by Taekwang Fine Chemical Co., Ltd.)

j) Zinc oxide: “Zinc Oxide, Species 2” (manufactured by Mitsui Mining & Smelting Co., Ltd.);

k) Stearic acid: “BEADS STEARIC ACID” (manufactured by NOF Corp.);

l) Antiaging agent: “NOCRAC 6C” (manufactured by Ouchi Shinko Chemical Industrial Co., Ltd.;

m) SULFUR: “MUCRON OT-20” (manufactured by Shikoku Chemicals Corp.);

n) Crosslinking agent: Sodium 1,6-hexamethylenedithiosulfate dihydrate “Duralink-HTS” (manufactured by a company Flexsys); and

k) Vulcanization promoter: N,N-dicyclohexyl-2-benzothiazolyl sulfenamide: “NOCCELER DZ-G” (manufactured by Ouchi Shinko Chemical Industrial Co., Ltd.)

### Examples 1 to 6, and Comparative Examples 1 to 4

### <Production of Rubber Compositions and Unvulcanized Rubber Compositions>

In each of the examples, a Banbury mixer was used to dry-mix individual raw materials (i.e., components other than any sulfur, any vulcanizer and any vulcanization promoter) shown in Table 3 (kneading period: 3 minutes; composition-discharging-temperature: 150° C.). In this way, a rubber composition was produced. Next, to the resultant rubber composition were added sulfur, a vulcanizer and a vulcanization promoter that are shown in Table 3, and then the Banbury mixer was used to dry-mix all the components (kneading period: 1 minute; composition-discharging-temperature: 90° C.). In this way, an unvulcanized rubber composition was produced. The blend proportion of any component in Table 3 is represented by the numerical value (phr) of the part(s) by weight of this component when the amount of the rubber component contained in the corresponding rubber composition is regarded as 100 parts by weight.

The unvulcanized rubber composition yielded in each of the working examples and the comparative examples was evaluated as described below. The evaluation results are shown in Table 3.

### <Wet Heat Resistant Adhesiveness Evaluation>

Products were used in each of which steel cords for belts (3×0.20+6×0.35 mm structure; ratio by mass of copper/zinc=64/36; brass plating which gave an adhesion amount of 5 g/kg) were arranged in parallel with each other at a drive-in density of 12 per 25-mm. Both surfaces of each of the products were covered with a rubber sheet having a thickness of 1 mm and made of an unvulcanized rubber composition. Two of these products were laminated onto each other to make the cords parallel with each other to produce an unvulcanized sample for a test. The sample was vulcanized at 150° C. for 30 minutes. This vulcanized sample was allowed to stand still in saturated water vapor of 105° C. temperature for 96 hours, and then an autograph “DCS 500” manufactured by Shimadzu Corp. was used to make a peeling test between the steel cords in the bilayered form (test velocity: 50 mm/min.). After the layers were peeled from each other, the rubber coverage factor of the steel cords was visually observed. The result was evaluated within the range of 0 to 100%. It is demonstrated that as the resultant numerical value is larger, the wet heat resistant adhesiveness is better.

### <Vulcanized Rubber Production>

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 3.

### <Odor Property Evaluation>

About an evaluation of the odor property of the vulcanized rubber, in accordance with JIS Z9080, into a 5 L bag made of polyethylene terephthalate were put 100 g of a shaped sheet (made of the vulcanized rubber) and an odorless air yielded by passing air through activated charcoal. The sheet was stored at a room temperature of 60° C. for 2 hours. The air inside the resultant odor bag was subjected to a sensory evaluation for grading the odor into 6 stages described below. The odor was evaluated according to the average of results obtained by five panelists.

1: No odor is felt.

2: The air gives a very faint odor.

3: The air gives a faint odor.

4: The air gives an odor clearly.

5: The air gives an odor strongly.

6: The air gives an odor very strongly.

TABLE 3

| | Comparative | Comparative | Comparative | Comparative | | | | | | |
|---|---|---|---|---|---|---|---|---|---|---|
| | Example 1 | Example 2 | Example 3 | Example 4 | Example 1 | Example 2 | Example 3 | Example 4 | Example 5 | Example 6 |
| Natural rubber | 100 | 100 | 100 | 100 | 100 | 100 | 100 | 100 | 100 | 100 |
| Carbon black | 60 | 60 | 60 | 60 | 60 | 60 | 60 | 60 | 60 | 60 |
| Inorganic | | | | 15 | 0.5 | 1 | 3 | 10 | 10 | |
| compound (A) | | | | | | | | | | |
| Inorganic | | | | | | | | | | 3 |
| compound (B) | | | | | | | | | | |
| Inorganic | | 3 | | | | | | | | |
| compound (C) | | | | | | | | | | |
| Inorganic | | | 3 | | | | | | | |
| compound (D) | | | | | | | | | | |
| Methylene receptor | 2 | 2 | 2 | 2 | 2 | 2 | 2 | 2 | 2 | 2 |
| Methylene donor | 2 | 2 | 2 | 2 | 2 | 2 | 2 | 2 | 2 | 2 |
| Organic acid cobalt | 2 | 2 | 2 | 2 | 2 | 2 | 2 | 2 | 2 | 2 |
| salt | | | | | | | | | | |
| Zinc oxide | 8 | 8 | 8 | 8 | 8 | 8 | 8 | 8 | 8 | 8 |
| Stearic acid | 1 | 1 | 1 | 1 | 1 | 1 | 1 | 1 | 1 | 1 |
| Antiaging agent | 2 | 2 | 2 | 2 | 2 | 2 | 2 | 2 | 2 | 2 |
| Sulfur | 6 | 6 | 6 | 6 | 6 | 6 | 6 | 6 | 6 | 6 |
| Crosslinking agent | | | | | | | | | 3 | |
| Vulcanization | 1 | 1 | 1 | 1 | 1 | 1 | 1 | 1 | 1 | 1 |
| promoter | | | | | | | | | | |
| Odor property | 5 | 5 | 6 | 2 | 4 | 4 | 3 | 2 | 2 | 4 |
| Wet heat resistant | 50 | 50 | 20 | 30 | 60 | 80 | 95 | 60 | 90 | 80 |
| adhesiveness | | | | | | | | | | |

What is claimed is:

1. A rubber composition, comprising an inorganic compound,
the inorganic compound being an aluminum silicate represented by general formula (1): xAl₂O₃.ySiO₂.zH₂O
wherein x and y are each independently an integer, y/x≥5, and z is a positive number; and
an amount of the inorganic compound being less than 15 parts by weight for 100 parts by weight of a rubber component in the rubber composition.

2. The rubber composition according to claim 1, comprising a vulcanizer, and a vulcanization promoter, and
a ratio by weight of the inorganic compound to a total of the vulcanizer and the vulcanization promoter (the “inorganic compound”/(the “vulcanizer”+the “vulcanization promoter”)) is 4 or less.

3. The rubber composition according to claim 1, which is for a tire tread.

4. The rubber composition according to claim 1, which is for a shoulder pad.

5. The rubber composition according to claim 1, which is for steel cord covering.

6. A pneumatic tire, using the rubber composition according to claim 1.

7. The pneumatic tire according to claim 6, which is for a heavy load.
